(19) United States
(12) Patent Application Publication
(10) Pub. No.: US 2015/0006466 A1
(43) Pub. Date: Jan. 1, 2015

(54) Multiversion concurrency control for columnar database and mixed OLTP/OLAP workload

(71) Applicants: Andreas Tonder, Weinheim (DE); Wolfgang Stephan, Heidelberg (DE); Ivan Schreter, Malsch (DE)

(72) Inventors: Andreas Tonder, Weinheim (DE); Wolfgang Stephan, Heidelberg (DE); Ivan Schreter, Malsch (DE)

(21) Appl. No.: 14/017,063

(22) Filed: Sep. 3, 2013

Related U.S. Application Data
(60) Provisional application No. 61/840,331, filed on Jun. 27, 2013.

(51) Int. Cl. G06F 17/30

(52) U.S. Cl. CPC G06F 17/30592; G06F 17/30348
USPC 707/602

(57) ABSTRACT

Online transactional processing (OLTP) transactions and online analytic processing (OLAP) transactions (e.g., aggregation operations, etc.) are both initiated on at least one table within a columnar oriented insert-only database in which at least a portion of the transactions are executed concurrently. Subsequently, it is checked, for each transaction, whether a corresponding record number is visible for the OLTP transaction using a create baselist bitvector and a delete baselist bitvector for the corresponding table. Thereafter, the OLTP transactions and the OLAP transactions having visible corresponding record numbers are executed. Related apparatus, systems, techniques and articles are also described.

### RELATED APPLICATION

This application claims priority to U.S. Pat. App. Ser. No. 61/840,331 filed on Jun. 27, 2013, the contents of which are hereby fully incorporated by reference.

### TECHNICAL FIELD

The subject matter described herein relates to techniques for multiversion concurrency control for columnar databases and a mixed OLTP/OLAP workload.

### BACKGROUND

Databases (DBMS) need to support multi version concurrency control of parallel transactions with several isolation levels (READ COMMITED, REPEATABLE READ and SERIALIZABLE). With columnar databases, each row in a columnar database table is identified by a consecutive physical row position. Write transactions insert new rows, which get a new row position and invalidate old rows in case of update and delete operations. A component in the DBMS must take care of the visibility of each row for concurrent transactions based on the given isolation level.

### SUMMARY

The current subject matter provides visibility of rows in a columnar database in a transactional context which is suited for mixed OLTP and OLAP workloads. In this regard, OLTP transactions can generally be characterized as requiring access to only a single row of a table and an OLAP transaction requiring access to a large number of row of a table. According to the current subject matter, two bitvectors can be provided per table having a size of the total number of rows in that table and a variable number of fixed size chunks which contain vectors of creation and deletion timestamps. In a first bitvector, bits can be set for all rows which are visible for all transactions. In a second bitvector, bits can be set for all rows which are not visible (because they have been deleted or updated) for all transactions. These bit vectors are used to provide proper visibility of rows for concurrent transactions based on the given isolation level.

In an interrelated aspect, online transactional processing (OLTP) transactions and online analytic processing (OLAP) transactions are both initiated on at least one table within a columnar oriented insert-only database. In some variations, at least a portion of the transactions are executed concurrently. Thereafter, for each transaction, it is checked whether a corresponding record number within the at least one table is visible for the transaction using a create baselist bitvector and a delete baselist bitvector for the at least one table. Subsequently, the OLTP and OLAP transactions having visible corresponding record numbers are executed.

The create baselist bitvector and the delete baselist vector can respectively include a variable number of fixed size chunks comprising vectors of creation timestamps and deletion stamps that are used to determine whether the corresponding record number is visible at an isolation level for the corresponding transaction.

A garbage collection process can be initiated that moves unconsolidated version information from the chunks to the create baselist bitvector and the delete baselist vector.

For some or all transactions, it can be determined whether the corresponding record number is visible for the transaction by iterating through the chunks in the create baselist bitvector and the chunks in the delete baselist bitvector to obtain unconsolidated information and corresponding time stamps.

The visibility checking for the transactions can be implemented by a transaction manager. The transaction manager can be called for each transaction to determine whether the corresponding record number is visible at an isolation level associated with the transaction. At least one of the OLAP transactions can be an aggregation operation.

Non-transitory computer program products are also described that store computer executable instructions, which, when executed by one or more data processors of at least one computer, causes the at least one computer to perform operations herein. Similarly, computer systems are also described that may include a processor and a memory coupled to the processor. The memory may temporarily or permanently store one or more programs that cause the processor to perform one or more of the operations described herein. In addition, operations specified by methods can be implemented by one or more data processors either within a single computing system or distributed among two or more computing systems.

The subject matter described herein provides many advantages. For example, with the current subject matter, read operations seeking to access a shared data structure are never blocked, so much better usage of CPU resources is possible, even under heavy table modification load. In addition, garbage collection of only internal data objects ensures pointer stability so that corresponding methods can be easily integrated with legacy code.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a system including a data storage application;

FIG. 2 is a diagram illustrating details of the system of FIG. 1;

FIG. 3 is a diagram illustrating contents of data structures; and

FIG. 4 is a process flow diagram illustrating a method for implementing the subject matter described herein.

### DETAILED DESCRIPTION

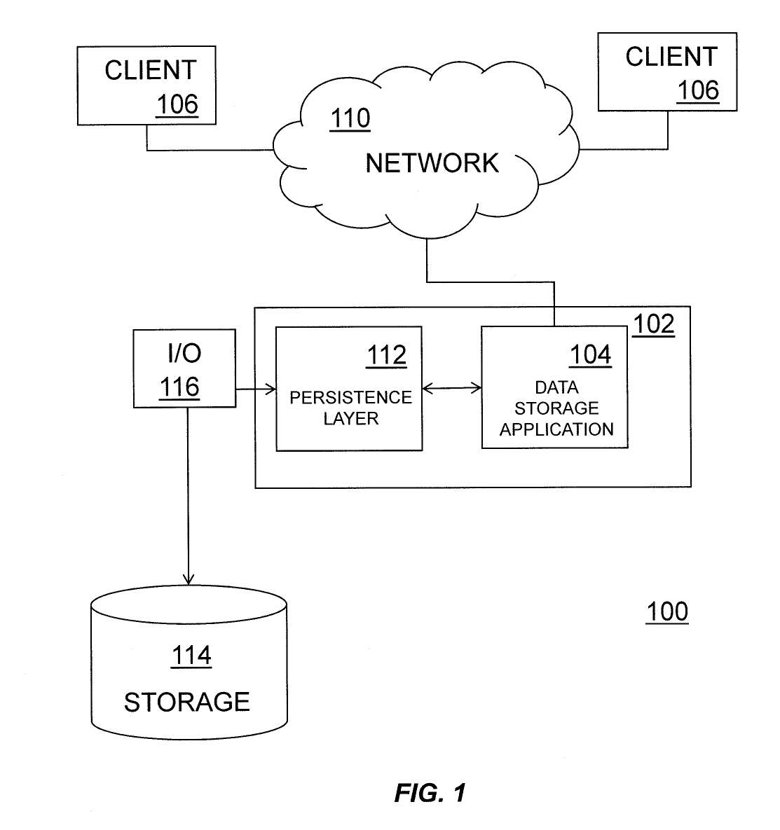

FIG. 1 shows an example of a system 100 in which a computing system 102, which can include one or more programmable processors that can be collocated, linked over one or more networks, etc., executes one or more modules, software components, or the like of a data storage application 104. The data storage application 104 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 102 as well as to remote users accessing the computing system 102 from one or more client machines 106 over a network connection 110. One or more user interface screens produced by the one or more first modules can be displayed to a user, either via a local display or via a display associated with one of the client machines 106. Data units of the data storage application 104 can be transiently stored in a persistence layer 112 (e.g. a page buffer or other type of temporary persistency layer), which can write the data, in the form of storage pages, to one or more storages 114, for example via an input/output component 116. The one or more storages 114 can include one or more physical storage media or devices (e.g. hard disk drives, persistent flash memory, random access memory, optical media, magnetic media, and the like) configured for writing data for longer term storage. It should be noted that the storage 114 and the input/output component 116 can be included in the computing system 102 despite their being shown as external to the computing system 102 in FIG. 1.

Data retained at the longer term storage 114 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

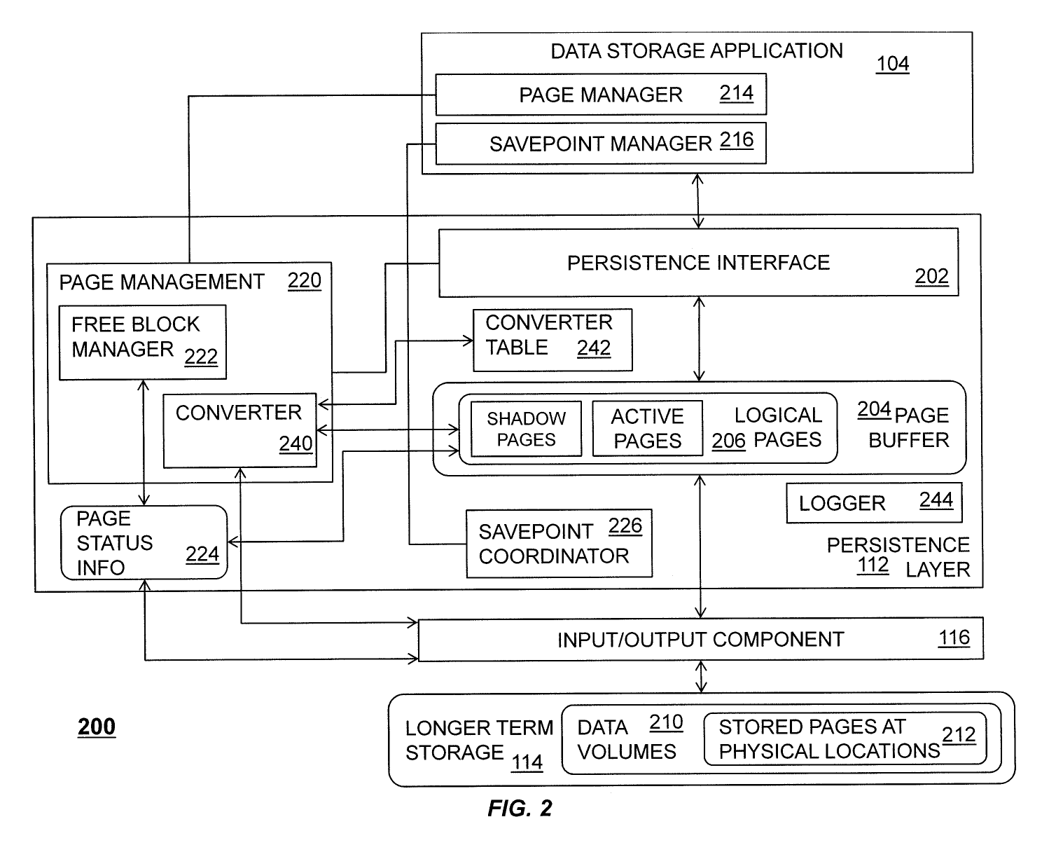

FIG. 2 shows a software architecture 200 consistent with one or more features of the current subject matter. A data storage application 104, which can be implemented in one or more of hardware and software, can include one or more of a database application, a network-attached storage system, or the like. According to at least some implementations of the current subject matter, such a data storage application 104 can include or otherwise interface with a persistence layer 112 or other type of memory buffer, for example via a persistence interface 202. A page buffer 204 within the persistence layer 112 can store one or more logical pages 206, and optionally can include shadow pages, active pages, and the like. The logical pages 206 retained in the persistence layer 112 can be written to a storage (e.g. a longer term storage, etc.) 114 via an input/output component 116, which can be a software module, a sub-system implemented in one or more of software and hardware, or the like. The storage 114 can include one or more data volumes 210 where stored pages 212 are allocated at physical memory blocks.

In some implementations, the data storage application 104 can include or be otherwise in communication with a page manager 214 and/or a savepoint manager 216. The page manager 214 can communicate with a page management module 220 at the persistence layer 112 that can include a free block manager 222 that monitors page status information 224, for example the status of physical pages within the storage 114 and logical pages in the persistence layer 112 (and optionally in the page buffer 204). The savepoint manager 216 can communicate with a savepoint coordinator 226 at the persistence layer 204 to handle savepoints, which are used to create a consistent persistent state of the database for restart after a possible crash.

In some implementations of a data storage application 104, the page management module of the persistence layer 112 can implement a shadow paging. The free block manager 222 within the page management module 220 can maintain the status of physical pages. The page buffer 204 can included a fixed page status buffer that operates as discussed herein. A converter component 240, which can be part of or in communication with the page management module 220, can be responsible for mapping between logical and physical pages written to the storage 114. The converter 240 can maintain the current mapping of logical pages to the corresponding physical pages in a converter table 242. The converter 240 can maintain a current mapping of logical pages 206 to the corresponding physical pages in one or more converter tables 242. When a logical page 206 is read from storage 114, the storage page to be loaded can be looked up from the one or more converter tables 242 using the converter 240. When a logical page is written to storage 114 the first time after a savepoint, a new free physical page is assigned to the logical page. The free block manager 222 marks the new physical page as “used” and the new mapping is stored in the one or more converter tables 242.

The persistence layer 112 can ensure that changes made in the data storage application 104 are durable and that the data storage application 104 can be restored to a most recent committed state after a restart. Writing data to the storage 114 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 344 can also be included to store the changes made to the data of the data storage application in a linear log. The logger component 244 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 244 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 112 can use a combination of undo log entries (from one or more logs) and shadow paging.

The persistence interface 202 can handle read and write requests of stores (e.g., in-memory stores, etc.). The persistence interface 202 can also provide write methods for writing data both with logging and without logging. If the logged write operations are used, the persistence interface 202 invokes the logger 244. In addition, the logger 244 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 244. For an entry of type “update”, for example, this would be the identification of the affected record and the after image of the modified data.

When the data application 104 is restarted, the log entries need to be processed. To speed up this process the redo log is not always processed from the beginning Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 244 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 244 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 244 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 104 can use shadow paging so that the savepoint manager 216 can write a transactionally-consistent savepoint. With such an arrangement, a data backup comprises a copy of all data pages contained in a particular savepoint, which was done as the first step of the data backup process. The current subject matter can be also applied to other types of data page storage.

The data storage application 104 can utilize multi-version concurrent control (MVCC) for transaction isolation and consistent reading. Each row of the database can be associated with a unique, monotonically-increasing identifier (RowID). When a new version of the record is created, this new version can also become a new RowID (i.e., due to MVCC semantics, old versions must be kept for parallel readers and will be cleaned only during garbage collection after commit).

References herein to pages can refer to pages of a table stored in memory of an in-memory database forming part of the data storage application 104. With the MVCC-based database table implementation, all internal transient data objects of a table can be versioned. These data objects can include table a header object, metadata object(s), other internal state(s) such as vector of loaded pages, dictionary hashes/trees for compressed columnar tables, and the like. In addition, all table control structures used by readers can be versioned. These structures include, for example, page lists, value indirection vectors, internal metadata, and more. Readers do not acquire any locks on data structure, but rather, work with a current version of a data structure until query or query plan operator ends. With this arrangement, old versions only remain for a short period of time (e.g., sub-seconds). As versioned objects are typically small, memory overhead is also small. In addition, even with OLTP systems, incompatible changes are rare (i.e., there are not many concurrent versions, etc.). Moreover, with some implementations, if older versions of prioritized/big objects (e.g., main part of a columnar table, etc.) still exist, no new version of the corresponding object can be created. For example, if there is a reader doing a scan on the main part of a columnar table, which started during columnar table merge from version n−1 to version n, this scan uses main part in version n−1. Even after merge to version n is finished, further merge from version n to version n+1 will be prevented as long as there are any scans running on main part in version n−1 (as this might increase memory demand prohibitively).

The current subject matter provides visibility of rows in a columnar database in a transactional context which is suited for mixed OLTP and OLAP workloads.

The two kinds of workloads can be roughly characterized as follows:
OLTP workload: DML (Data Manipulation Language) and DQL (Data Query Language) operations on few records of a table
OLAP workload: DML and DQL operations on large portions of a table (e.g. aggregation)

The implementation can include 2 bitvectors per table of the size of the total number of rows in that table and a variable number of fixed size chunks which contain vectors of creation and deletion timestamps.

In bitvector 1 bits can be set for all rows which are visible for all transactions. In bitvector 2 bits can be set for all rows which are not visible (because they have been deleted or updated) for all transactions. The bitvectors are denoted as “create baselist bitvector” and “delete baselist bitvector”.

Besides rows which are visible for either all or no transactions, exist rows can be provided that are visible only for some transactions, depending on the isolation level. For example transaction 1 inserted a row, transaction 2 started before transaction 1 was committed, so it must not see the inserted row.

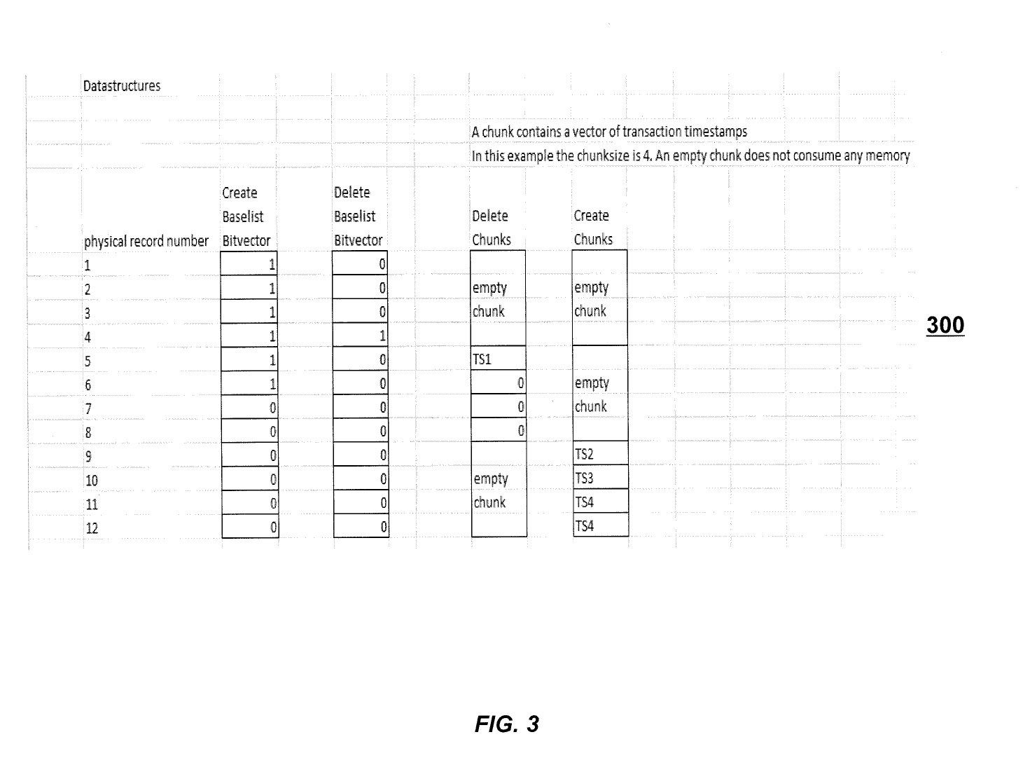

For such partly visible rows, fixed size chunks (chunk size=1024) can be created that contain a vector (size=1024) of creation timestamps (CTS) or deletion timestamps (DTS). FIG. 3 is a diagram 300 that shows an example of the contents of the data structures. For simplicity reasons the chunksize is 4 (instead of 1024).

Table 1 below provides some examples on the visibility of some of the physical records:

TABLE 1

| Physical record number | Visibility |
|---|---|
| 1 | this record is visible for all transactions |
| 4 | this record is not visible by any transaction |
| | (note that such record might be subject to |
| | some garbage collection run) |
| 5 | this record was deleted by Transaction |
| | TS1; |
| | to check whether this deletion is visible for |
| | a transaction T, T has to check visibility of |
| | TS1 with the help of the transaction |
| | manager |
| 9 | This record was inserted by Transaction |
| | TS2; |
| | to check whether this insertion is visible |
| | for a transaction T, T has to check visibility |
| | of TS2 with the help of the transaction |
| | manager |

Garbage collection. Please note that in productive systems may only be only a small number of chunks and most of the visibility information will be contained in the “create baselist bitvector” and in the “delete baselist bitvector”. This is because from time to time a garbage collection run may take place which will try to move unconsolidated version information (i.e. the information stored in the chunks) to the baselist. This is possible when the timestamp in a chunk entry becomes visible for all transactions. Once a chunk is completely empty (i.e. does not contain any valid transaction timestamps) it can be deallocated.

OLTP Operations.

The current subject matter is well suited for OLTP operations because visibility check for single rows within a table is fast because it requires only few operations, and only in cases where the record cannot be found in the baselist, a transaction manager has to be asked to check validity.

The following provides a sample algorithm: “check if physical record number N is visible for current transaction”
1) Assumptions:
   let create chunks be stored in “c_chunkvec” consisting of pointers to chunks
   Let delete chunks be stored in “d_chunkvec” consisting of pointers to chunks and let “CHUNKSIZE” be the size of the timestamp-vector inside a chunk.
   Let “timestampvec” denote the timestamp vector inside a chunk
   Let IS_VISIBLE (timestamp) be a function which checks whether a given transaction timestamp is visible for the calling transaction.

BEGIN FUNCTION
input: physical record number N
returns: true if record is visible, false otherwise
if N-th bit set in “create baselist bitvector” AND NOT

set in “delete baselist bitvector”:
// check if delete chunk contains information
d_chunk := d_chunkvec[N / CHUNKSIZE]
if d_chunk!=0

TS := d_chunk−>timestampvec[N % CHUNKSIZE]
if TS!=0
return NOT IS_VISIBLE( TS )
else

return TRUE

end if

else

return TRUE

end if

end if
if N-th bit not set in “create baselist bitvector”:

//note: this else branch will rarely be reached because most

information will be //contained in the baselists

d_chunk := d_chunkvec[N / CHUNKSIZE]
if d_chunk!=0

TS := d_chunk−>timestampvec[N % CHUNKSIZE]
if TS!=0 and IS_VISIBLE( TS )
return FALSE
end if

end if
c_chunk := c_chunkvec[N / CHUNKSIZE]
if c_chunk!=0

TS := c_chunk−>timestampvec[N % CHUNKSIZE]
if TS!=0 and IS_VISIBLE( TS )
return TRUE

end if

end if
return FALSE

END FUNCTION

OLAP Operations.

In addition, the current MVCC implementation is well suited for OLAP workload. For OLAP workloads (such as aggregation) it can be required to create a full list of visible records (e.g. a bitvector over the complete size of the table where for each visible record a bit is set). This operation can also be accomplished performantly because in productive systems a large portion of the visibility information is contained in the two baselists, and the information in the chunks is rather small.

The following provides a sample algorithm: “compute a complete visibility bitvector over the complete table for the current transaction”
2) Assumptions:
   let create chunks be stored in “c_chunkvec” consisting of pointers to chunks
   Let delete chunks be stored in “d_chunkvec” consisting of pointers to chunks and let “CHUNKSIZE” be the size of the timestamp-vector inside a chunk.
   Let “timestampvec” denote the timestamp vector inside a chunk
   Let IS_VISIBLE (timestamp) be a function which checks whether a given transaction timestamp is visible for the calling transaction.

BEGIN FUNCTION
input: none
returns: visibility bitvector “result_bv”

// bitvector operation to determine baselist visbility

result_bv := “create baselist bitvector “

AND NOT “delete baselist bitvector”

// iterate over “create chunks” to get unconsolidated information
For( i:=0; i<size(c_chunkvec); i:=i+1)

If c_chunkvec[i]==0: continue
For( j:=0; j<size(c_chunkvec[i]−>timestampvec); j:=j+1)

TS:= chunkvec[i]−>timestampvec[j]
if TS==0: continue
result_bv[i*CHUNKSIZE+j] := IS_VISIBLE(TS)

end for

end for
// iterate over “delete chunks” to get unconsolidated information
For( i:=0; i<size(d_chunkvec); i:=i+1)

If d_chunkvec[i]==0: continue
For( j:=0; j<size(d_chunkvec[i]−>timestampvec); j:=j+1)

TS:= d_chunkvec[i]−>timestampvec[j]
if TS==0: continue
result_bv[i*CHUNKSIZE+j] :=

result_bv[i*CHUNKSIZE+j] AND NOT IS_VISIBLE(TS)

end for

end for
RETURN result_bv
END FUNCTION

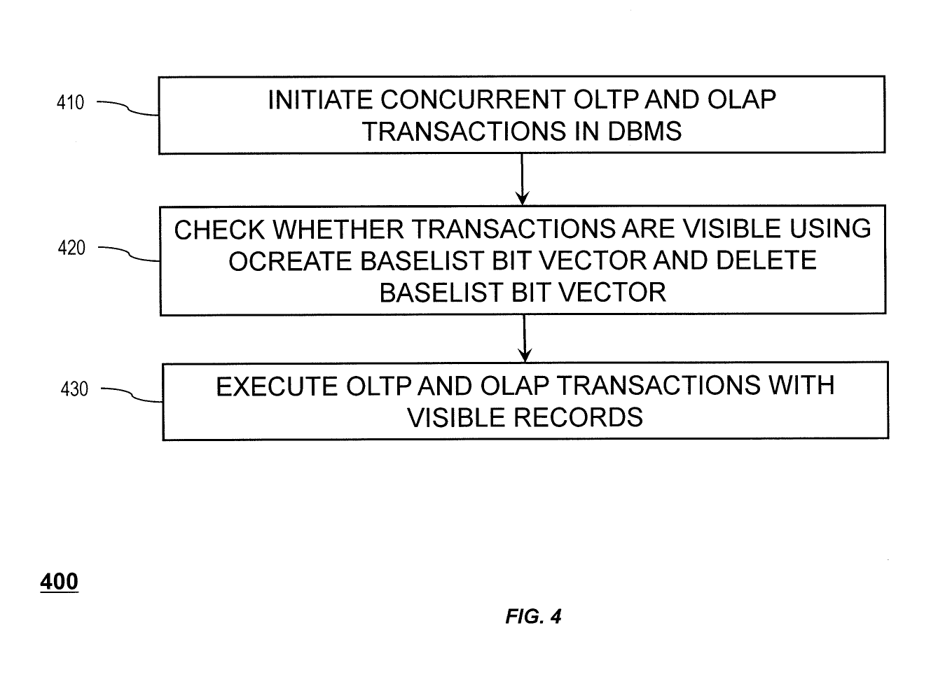

FIG. 4 is a process flow diagram 400 in which, at 410, online transactional processing (OLTP) transactions and online analytic processing (OLAP) transactions (e.g., aggregation operations, etc.) are both initiated on at least one table within a columnar oriented insert-only database in which at least a portion of the transactions are executed concurrently. Subsequently, at 420, it is checked, for each transaction, whether a corresponding record number is visible for the OLTP transaction using a create baselist bitvector and a delete baselist bitvector for the corresponding table. Thereafter, at 420, the OLTP transactions and the OLAP transactions having visible corresponding record numbers are executed.

The create baselist bitvector and the delete baselist vector can respectively comprise a variable number of fixed size chunks comprising vectors of creation timestamps and deletion stamps that are used to determine whether the corresponding record number is visible at an isolation level for the corresponding transaction. A garbage collection process can move unconsolidated version information from the chunks to the create baselist bitvector and the delete baselist vector.

For each OLAP transaction, the create baselist bitvector can be computed over a complete table for the OLAP transaction. Thereafter, it can be determined, whether the corresponding record number is visible for the OLAP transaction by iterating through the chunks in the create baselist bitvector and the chunks in the delete baselist bitvector to obtain unconsolidated information and corresponding time stamps. Furthermore, the visibility checking for the transactions can be implemented by a transaction manager (which can be called).

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A method comprising:
initiating both online transactional processing (OLTP) transactions and online analytic processing (OLAP) transactions on at least one table within a columnar oriented insert-only database, wherein at least a portion of the transactions are executed concurrently;
checking, for each transaction, whether a corresponding record number within the at least one table is visible for the transaction using a create baselist bitvector and a delete baselist bitvector for the at least one table; and
executing the OLTP transactions and the OLAP transactions having visible corresponding record numbers.

2. A method as in claim 1, wherein the create baselist bitvector and the delete baselist vector respectively comprise a variable number of fixed size chunks comprising vectors of creation timestamps and deletion stamps that are used to determine whether the corresponding record number is visible at an isolation level for the corresponding transaction.

3. A method as in claim 2, further comprising:
executing a garbage collection process moving unconsolidated version information from the chunks to the create baselist bitvector and the delete baselist vector.

4. A method as in claim 3, further comprising:
determining whether the corresponding record number is visible for at least one transaction by iterating through the chunks in the create baselist bitvector and the chunks in the delete baselist bitvector to obtain unconsolidated information and corresponding time stamps.

5. A method as in claim 1, wherein the visibility checking for the transactions are implemented by a transaction manager.

6. A method as in claim 5, further comprising:
calling, for each transaction, the transaction manager to determine whether the corresponding record number is visible at an isolation level associated with the transaction.

7. A method as in claim 1, wherein at least one of the OLAP transactions comprises an aggregation operation.

8. A method as in claim 1, wherein the initiating, checking, and executing are implemented by at least one data processor forming part of at least one computing system.

9. A non-transitory computer program product storing instructions, which when executed by at least one data processor of at least one computing system, result in operations comprising:
initiating both online transactional processing (OLTP) transactions and online analytic processing (OLAP) transactions on at least one table within a columnar oriented insert-only database, wherein at least a portion of the transactions are executed concurrently;
checking, for each transaction, whether a corresponding record number within the at least one table is visible for the transaction using a create baselist bitvector and a delete baselist bitvector for the at least one table; and
executing the OLTP transactions and the OLAP transactions having visible corresponding record numbers.

10. A computer program product as in claim 9, wherein the create baselist bitvector and the delete baselist vector respectively comprise a variable number of fixed size chunks comprising vectors of creation timestamps and deletion stamps that are used to determine whether the corresponding record number is visible at an isolation level for the corresponding transaction.

11. A computer program product as in claim 10, wherein the operations further comprise:
executing a garbage collection process moving unconsolidated version information from the chunks to the create baselist bitvector and the delete baselist vector.

12. A computer program product as in claim 11, wherein the operations further comprise:
determining whether the corresponding record number is visible for at least one transaction by iterating through the chunks in the create baselist bitvector and the chunks in the delete baselist bitvector to obtain unconsolidated information and corresponding time stamps.

13. A computer program product as in claim 9, wherein:
the visibility checking for the transactions are implemented by a transaction manager;
the operations further comprise:
calling, for each transaction, the transaction manager to determine whether the corresponding record number is visible at an isolation level associated with the transaction.

14. A computer program product as in claim 9, wherein at least one of the OLAP transactions comprises an aggregation operation.

15. A system comprising:
at least one data processor; and
memory storing instructions, which when executed by the at least one data processor, result in operations comprising:
initiating both online transactional processing (OLTP) transactions and online analytic processing (OLAP) transactions on at least one table within a columnar oriented insert-only database, wherein at least a portion of the transactions are executed concurrently;
checking, for each transaction, whether a corresponding record number within the at least one table is visible for the transaction using a create baselist bitvector and a delete baselist bitvector for the at least one table; and
executing the OLTP transactions and the OLAP transactions having visible corresponding record numbers.

16. A system as in claim 15, wherein the create baselist bitvector and the delete baselist vector respectively comprise a variable number of fixed size chunks comprising vectors of creation timestamps and deletion stamps that are used to determine whether the corresponding record number is visible at an isolation level for the corresponding transaction.

17. A system as in claim 16, wherein the operations further comprise:
executing a garbage collection process moving unconsolidated version information from the chunks to the create baselist bitvector and the delete baselist vector.

18. A system as in claim 17, wherein the operations further comprise:
determining whether the corresponding record number is visible for at least one transaction by iterating through the chunks in the create baselist bitvector and the chunks in the delete baselist bitvector to obtain unconsolidated information and corresponding time stamps.

19. A system as in claim 15, wherein the visibility checking for the transactions are implemented by a transaction manager.

20. A system as in claim 19, wherein the operations further comprise:
calling, for each transaction, the transaction manager to determine whether the corresponding record number is visible at an isolation level associated with the transaction.
